(19) United States
(12) Patent Application Publication
(10) Pub. No.: US 2025/0252156 A1
(43) Pub. Date: Aug. 7, 2025

(54) SYNTHETIC DATA GENERATION METHOD FOR TRAINING ARTIFICIAL INTELLIGENCE MODEL AND CLIENT APPARATUS

(71) Applicant: Cubig Corp., Seoul (KR)

(72) Inventor: Min Chan CHUNG, Seoul (KR)

(21) Appl. No.: 19/039,319

(22) Filed: Jan. 28, 2025

(30) Foreign Application Priority Data
Feb. 5, 2024 (KR) 10-2024-0017564

(51) Int. Cl. G06F 18/214; G06F 21/62

(52) U.S. Cl. CPC G06F 18/214; G06F 21/6254

(57) ABSTRACT

Proposed is a method of generating synthetic data, which includes receiving, by a client apparatus, original data including personal information, acquiring, by the client apparatus, seed data based on the original data, transmitting, by the client apparatus, the seed data to a server, receiving, by the client apparatus, first candidate synthetic data which is generated based on the seed data from the server, validating, by the client apparatus, the first candidate synthetic data based on a similarity between the first candidate synthetic data and the original data, and storing, by the client apparatus, the first candidate synthetic data as a member of candidate synthetic dataset if the first candidate synthetic data is valid synthetic data from the validation result.

### CROSS REFERENCE TO RELATED APPLICATIONS

The present application claims priority to Korean Patent Application No. 10-2024-0017564, filed on Feb. 5, 2024, the entire contents of which are incorporated herein for all purposes by this reference.

### BACKGROUND

### Field

The present disclosure relates to a technique for generating synthetic data from original data including sensitive information.

### Description of the Related Art

An artificial intelligence model needs large amounts of training dataset for improving performance of the model. Original training dataset may include personal information or sensitive information. To prevent leakage of personal information, developer can use synthetic data instead of the original training dataset including personal information.

### SUMMARY

In one or more aspects of the present disclosure, a method of generating synthetic data, which includes receiving, by a client apparatus, original data including personal information, acquiring, by the client apparatus, seed data based on the original data, transmitting, by the client apparatus, the seed data to a server, receiving, by the client apparatus, first candidate synthetic data which is generated based on the seed data from the server, validating, by the client apparatus, the first candidate synthetic data based on a similarity between the first candidate synthetic data and the original data, and storing, by the client apparatus, the first candidate synthetic data as a member of candidate synthetic dataset if the first candidate synthetic data is valid synthetic data from the validation result. In one or more aspects of the present disclosure, a client apparatus for collecting synthetic data, which includes an interface device configured to receive original data including personal information, a communication device configured to receive first candidate synthetic data which is generated based on seed data from the server, a computation device configured to validate the first candidate synthetic data based on a similarity between the first candidate synthetic data and the original data, and determine the first candidate synthetic data as valid synthetic data if the similarity is higher above a threshold and a storage device configured to store the first candidate synthetic data as a member of candidate synthetic dataset if the first candidate synthetic data is valid synthetic data based on the validation result.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of a system for generating synthetic data without leakage of personal information.

FIG. 2 illustrates an example of a process of generating synthetic data.

FIG. 3 illustrates an example of generating synthetic data from original data.

FIG. 4 illustrates an example of a flowchart for building an artificial intelligence model using synthetic data.

FIGS. 5A-5E are an example of generated synthetic data.

FIG. 6 illustrates an example of a client apparatus for generating synthetic data.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The present disclosure is related with a technique of generating synthetic data that has a similar distribution to original data including personal information or sensitive information. The similar distribution may mean that the distribution of features in the original data is statistically similar to that in the synthetic data. Further, the similar distribution may mean that the distribution of feature of the original data is similar with the distribution of feature of the synthetic data in a feature space.

Personal information and sensitive information may have difference definition in legal. Personal information refers to data that can identify an individual, such as names, social security numbers, or facial images. Sensitive information includes data related to political views, health, sexual life, or other private matters that might significantly infringe on privacy.

Personal information may be used broadly here to include sensitive information.

Further, personal information may be used more broadly here to include information that is not intended to be exposed to third parties by a user or inner party.

Original data may include personal information which could be at risk of exposure. The type of original data may be various. For example, the type of original data may be text, image, video, audio, and etc.

Synthetic data can be used as training data for building artificial intelligence models. Collection of training dataset can be costly and time-consuming. Moreover, the collection of training dataset can be incomplete unintentionally. For example, when developing a facial recognition model, the performance of the facial recognition model may be biased in case of certain ethnicities due to bias of the training data. In order to solve this problem, developers want to generate synthetic data (facial images) for various ethnicities to improve the performance of the model. However, there is a risk of leaking personal information during generating synthetic data to third parties.

The present disclosure here provides a method of generating synthetic data for building artificial intelligence models without leaking personal information.

The synthetic data described here could apply to various applications including medical (e.g., disease diagnosis), security (e.g., user authentication), and natural language processing (e.g., Q&A services), etc. The synthetic data can be training dataset for building artificial intelligence models in various fields.

There are various methods for generating the synthetic data. For example, Monte Carlo-based techniques may be used to generate data with a similar statistical distribution to the original data. For example, the model for generating the synthetic data is sample-based variation model, a demonstration-based variation model, etc. Alternatively, a deep learning model may be used to generate data. The deep leaning model used for the generating synthetic data could be one of various models. The various models may include an autoencoder, a generative adversarial network, a transformer-based model, or a diffusion model. Hereinafter, the model for generating the synthetic data is referred as a data generation model.

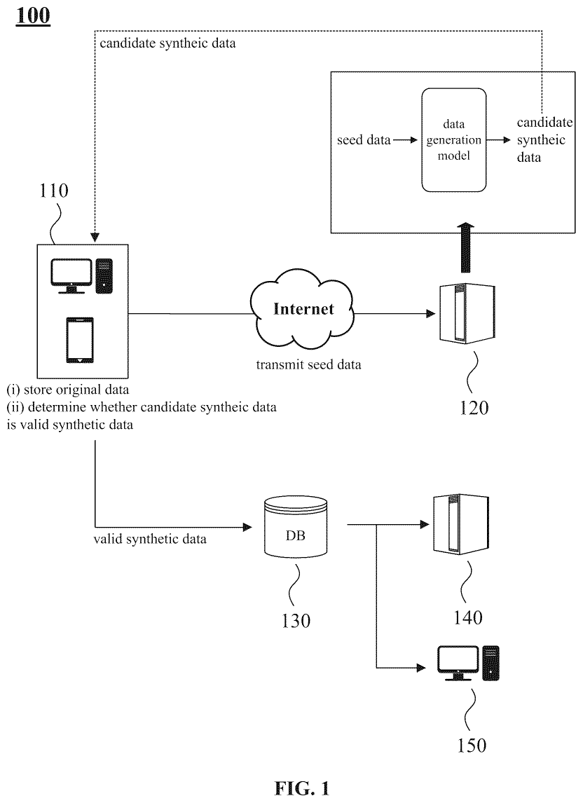

FIG. 1 illustrates an example of a system 100 for generating synthetic data without leakage of personal information.

The client apparatus 110 may be a terminal used by a user. The client apparatus 110 may be any of various devices such as a smart device, a personal computer (PC), a laptop computer, a wearable device, a smart speaker, and the like. The client apparatus 110 acquires original data including the personal information. The client apparatus 110 may receive the original data as input by the user. Further, the client apparatus 110 may receive the original data from an external apparatus (a server or an external storage media). The client apparatus 110 may store the original data.

The client apparatus 110 may generate seed data (seed population) based on the original data. The client apparatus 110 may transmit seed data (seed population) to the server 120. The seed data is input data for generating candidate synthetic data. The seed data can be generated in various ways. In the process of generation the seed data, the personal information in the original data has been removed or obfuscated.

Alternatively, the seed data may be generated by another device or by the server 120.

The server 120 generates the candidate synthetic data. The server 120 may input the seed data into a data generation model to generate the candidate synthetic data. The data generation model is a pre-trained model. The data generation model generates the candidate synthetic data. For example, the data generation model may be a sample-based variation model, a demonstration-based variation model, a deep learning model, etc.

The server 120 transmits the generated candidate synthetic data to the client apparatus 110.

The server 120 may generate a plurality of candidate synthetic data based on the seed data using the data generation model. The server 120 may input a plurality of seed data, one by one, into the data generation model to generate the plurality of candidate synthetic data respectively. In this process, the server 120 can generate a candidate synthetic dataset including the plurality of candidate synthetic data.

The client apparatus 110 may receive the candidate synthetic data from the server 120. And, the client apparatus 110 can determine whether the candidate synthetic data is similar to the original data or not. The client apparatus 110 may measure the similarity between the candidate synthetic data and the original data by comparing the features of the original data with those of the candidate synthetic data. For example, the client apparatus 110 may extract the features of the original data by an encoder consisting of convolutional layers. The encoder takes the original data as input and outputs the features of the original data. And, the client apparatus 110 may extract the features of the candidate synthetic data by an encoder consisting of convolutional layers. The encoder takes the candidate synthetic data as input and outputs the features of the candidate synthetic data. The client apparatus 110 can measure the similarity between the candidate synthetic data and the original data based on the distance (e.g., cosine distance) between the features of the original data and the features of the candidate synthetic data in the feature space. If the distance between the features of the original data and the candidate synthetic data is small than a threshold, the client apparatus 110 may determine the candidate synthetic data as valid synthetic data.

The client apparatus 110 may receive the candidate synthetic dataset including the plurality of candidate synthetic data. The client apparatus 110 may select at least one valid synthetic data from the candidate synthetic dataset based on the similarity between the original data and the candidate synthetic data in the candidate synthetic dataset. And the client apparatus 110 may collect a valid synthetic dataset including a plurality of the valid synthetic data.

Further, the client apparatus 110 may transmit the selected valid synthetic data to the server 120 as another seed data for generating synthetic data.

The client apparatus 110 may transmit the valid synthetic dataset to a database (DB) 130. Then, a service server 140 or a user terminal 150 can generate a specific artificial intelligence model using the valid synthetic dataset.

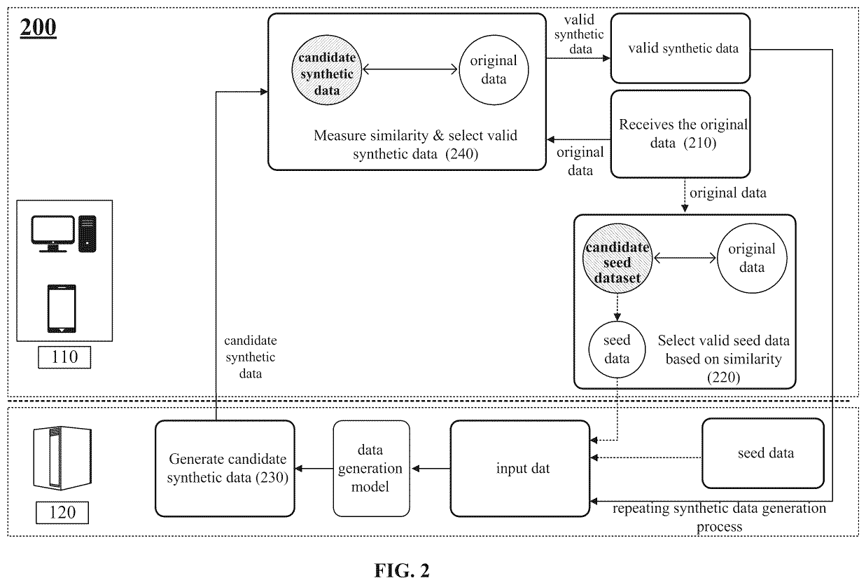

FIG. 2 illustrates an example of a process 200 of generating synthetic data.

The client apparatus 110 receives the original data 210. The original data includes certain personal information. The type of original data may be various, such as images, videos, text, or audio.

The client apparatus 110 can generate the seed data.

The client apparatus 110 can generate the seed data using various techniques. For example, the client apparatus 110 may use a deep learning model, such as Stable Diffusion, ChatGPT, Llama2, etc., to generate the seed data. The deep learning model may be referred to as a seed generation model. The client apparatus 110 may input the original data into the seed generation model to generate the seed data. In this case, the client apparatus 110 can improve the quality of the seed data with prompt engineering. In the process of generation the seed data, the personal information in the original data has been removed or obfuscated.

The client apparatus 110 can further enhance the quality of the seed data with statistical values of the original data. In this case, the client apparatus 110 may generate the see data which has a similar distribution of features with that of the original data.

Further, the client apparatus 110 can further enhance the quality of the seed data with class information of the original data. In this case, the client apparatus 110 may generate the see data which has same class information of the original data.

The client apparatus 110 can generate a candidate seed dataset including a plurality of seed data. For example, the client apparatus 110 may input “the original data with additional prompts” into the seed generation model to generate seed data. In this process, the client apparatus 110 may modify or exchange the additional prompts each time before inputting it into the seed generation model to generate the plurality of seed data which are difference one another. Alternatively, the client apparatus 110 may extract prompts from the original data, and input only the extracted prompts into the seed generation model to generate seed data.

Alternatively, the client apparatus 110 may use a plurality of the seed generation models. The client apparatus 110 input the original data into a seed generation model of the plurality of the seed generation models to generate first seed data. Then the client apparatus 110 input the original data into another seed generation model of the plurality of the seed generation models to generate second seed data. In this process, the client apparatus 110 may generate the candidate seed dataset by repeating the generation processes.

The client apparatus 110 can select valid seed data from the candidate seed dataset based on the similarity between each candidate seed data and the original data 220. In this case, the similarity can be measured as the similarity (distance) between the original data and the candidate seed data in feature space. The client apparatus 110 can select at least one candidate seed data which has the similarity to the original data above a threshold (=the distance from the original data within a threshold) from the candidate seed dataset. The selected candidate seed data may be referred to as valid seed data. Further, the client apparatus 110 can select a plurality of valid seed data from the candidate seed dataset.

Alternatively, if the number of required seed data is N, the client apparatus 110 can select the top N candidate seed data based on the similarity from the candidate seed dataset as valid seed dataset.

The valid seed data is an input data for the data generation model to generate the synthetic data. The server 120 receives the seed data. The server 120 can receive the seed data from the client apparatus 110. The server 120 may also receive seed data from another device.

Alternatively, the server 120 can generate the seed data. The server 120 may receive preprocessed original data from the client apparatus 110. In this case, the client apparatus 110 may preprocess the original data by removing or obfuscating the personal information, and transmit the preprocessed original data.

Further, the server 120 can generate seed data using the seed generation model. The server 120 can improve the quality of the seed data through prompt engineering.

In another embodiment, the seed data may be selected from public dataset that have a features distribution similar to that of the original data. In this case, the client apparatus 110 may select specific data which has a similar distribution of feature with the original data from the public dataset as the seed data. The client apparatus 110 may select at least one seed data which has the similarity to the original data above a threshold (=the distance from the original data within a threshold) from the public dataset. Alternatively, the client apparatus 110 may select at least one seed data which is clustered in same group with the original data from the public dataset. In this case, the client apparatus 110 may cluster the original data and the public dataset based on the features of data.

The server 120 may input the seed data into the data generation model to generate candidate synthetic data 230. The server 120 may generate a candidate synthetic dataset including a plurality of the candidate synthetic data. The server 120 transmits the candidate synthetic data to the client apparatus 110.

The server 120 may generate the plurality of candidate synthetic data based on the seed data using the data generation model. The server 120 may input a plurality of seed data, one by one, into the data generation model to generate the plurality of candidate synthetic data respectively. In this process, the server 120 can generate a candidate synthetic dataset including the plurality of candidate synthetic data. The server 120 transmits the candidate synthetic dataset to the client apparatus 110.

The data generation model can be of various types. The data generation model may be at least one of sample-based variation models, demonstration-based variation models, deep learning models, etc. Further, the data generation model can be a combination of multiple models.

The client apparatus 110 evaluates the similarity between candidate synthetic data and the original data 240. As mentioned before, the client apparatus 110 can measure the similarity by comparing the distance between the features of the candidate synthetic data and the original data. The client apparatus 110 can determine the candidate synthetic data as valid synthetic data if the distance between the features of the candidate synthetic data and the original data is small than a certain threshold. The threshold may be set experimentally based on the data type, etc. The client apparatus 110 can store the valid synthetic data. The client apparatus 110 may select the valid synthetic dataset including a plurality of the valid synthetic data from the candidate synthetic dataset.

Further, the client apparatus 110 may transmit the valid synthetic data (first valid synthetic data) to the server 120. The client apparatus 110 may transmit the most similar synthetic data with the original data from the valid synthetic dataset to the server 120. The server 120 may take the received the first valid synthetic data as input to the data generation model for generating additional candidate synthetic data. The server 120 may transmit the additional candidate synthetic data to the client apparatus 110.

In this case, the client apparatus 110 may determine the additional candidate synthetic data as second valid synthetic data by the similarity between the additional candidate synthetic data and the original data. By repeating this process, the client apparatus 110 may collect multiple valid synthetic data.

In one embodiment, the client apparatus 110 can calculate the similarity scores for each the candidate synthetic data in the candidate synthetic dataset. The similarity scores can be calculated by the distance between the features of candidate synthetic data and the original data. The client apparatus 110 may select the final synthetic dataset which has similarity scores above a certain threshold from the candidate synthetic dataset.

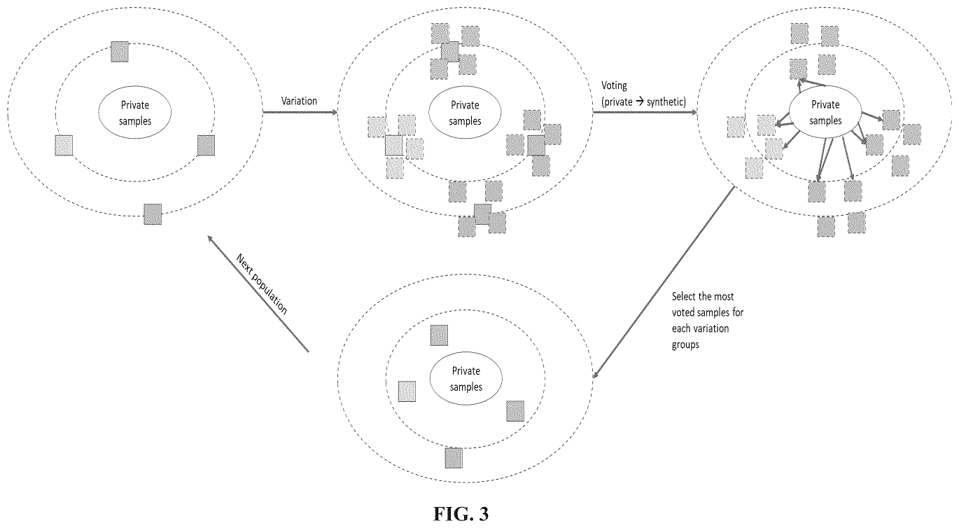

FIG. 3 illustrates an example process 300 of generating synthetic data from original data.

As explain before, the client apparatus 110, server 120, or other device can generate seed data 310. In FIG. 3, the seed dataset consists of four pieces of seed data. As mentioned before, the seed data has a similar distribution of features to that of the original data, but the personal information in the original data has been removed or obfuscated.

The server 120 may use the data generation model to generate candidate synthetic datasets including multiple candidate synthetic data based on each seed data of the seed dataset 320. In FIG. 3, the server 120 generates four candidate synthetic datasets based on each seed data of the seed dataset. In other word, the server 120 generates four groups of candidate synthetic data.

The client apparatus 110 receives the four candidate synthetic datasets from the server 120. The client apparatus 110 may evaluate a candidate synthetic dataset by a voting process 330 by comparing each candidate synthetic data in the candidate synthetic dataset with the original data.

The client apparatus 110 can evaluate the similarity between each candidate synthetic data in the candidate synthetic dataset and the original data. As mentioned before, the similarity can be measured based on the distance between the features of the each candidate synthetic data and that of the original data. The client apparatus 110 can select specific candidate synthetic data as valid synthetic data from the candidate synthetic dataset if the distance between the features of the specific candidate synthetic data and that of the original data is smallest among the candidate synthetic dataset. In other word, the specific candidate synthetic data (the valid synthetic data) is most similar with the original data among the candidate synthetic dataset.

The client apparatus 110 may select each valid synthetic data for each group of candidate synthetic data 340. In FIG. 3, the client apparatus 110 select four pieces of valid synthetic data from the entire candidate data set.

Further, the client apparatus 110 can select the valid synthetic data as input data (new seed data) for generating another synthetic data in the next phase. Then, the client apparatus 110 may transmit the selected valid synthetic data to the server 120 to generate another synthetic data.

The client apparatus 110 and server 120 can repeat the process of FIG. 3 to generate multiple valid synthetic data. In this process, the client apparatus 110 can collect multiple valid synthetic data based on their similarity to the original data.

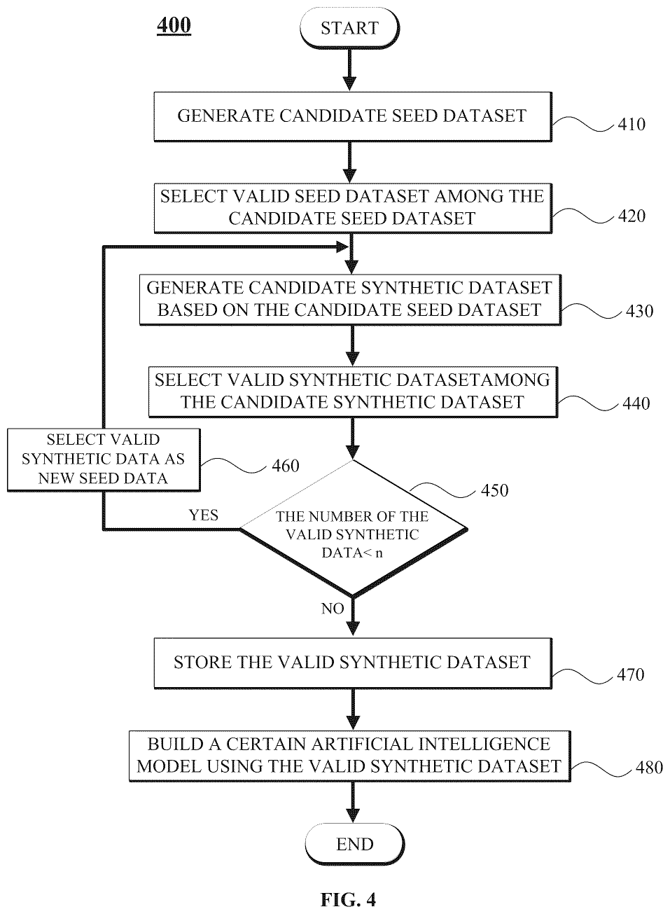

FIG. 4 illustrates an example of a flowchart for building an artificial intelligence model using synthetic data. FIG. 4 illustrates an example process 400 in which the client apparatus collects valid synthetic data through a similar process of the process in FIG. 3.

The client apparatus can generate seed data.

It is required that the seed data has a distribution of features similar to that of the original data. And, it is further required that the seed data do not include the personal information of the original information.

The client apparatus can generate seed data using statistical information or class information of the original data from the original data including personal information.

Further, the client apparatus can generate more valid seed data using a hyperscale AI as like LLM (Large Language Model). In this case, the client apparatus can generate the seed data through prompt tuning. Alternatively, seed data can be generated by devices other than the client apparatus, such as a server or another device.

The seed data has a similar distribution of features to that of the original data, but the personal information in the original data has been removed or obfuscated in the process of generating the seed data.

The client apparatus can generate a candidate seed dataset consisting of multiple candidate seed data 410. The client apparatus may generate the multiple candidate seed data by repeating generation of the candidate seed data.

The client apparatus can evaluate the similarity between each candidate seed data in the candidate seed dataset and the original data. The similarity may be measured as the distance between the features of the original data and that of the candidate seed data in the feature space. The client apparatus may select valid seed data based on the similarity 420. The client apparatus can select seed dataset including multiple valid seed data based on the similarity.

The server receives the selected seed data or the seed dataset. The server may input the seed data into a data generation model to generate candidate synthetic data 430. The candidate synthetic data does not include the personal information of the original data due to the seed data without the personal information. The server can generate multiple candidate synthetic data (a candidate synthetic dataset) using the seed dataset.

The client apparatus may select valid synthetic data from the candidate synthetic dataset generated by the server 440. As mentioned before, the client apparatus can evaluate the similarity between the candidate synthetic data and the original data. The client apparatus may select at least one synthetic data with a distribution similar to the original data as the valid synthetic data. The valid synthetic data refers to data has a similar distribution of features with that of the original data without the personal information.

It is assumed that the required number of valid synthetic data is n. If the number of valid synthetic data is less than n (YES in 450), the client apparatus may select the valid synthetic data as new seed data 460. Then, the client apparatus transmits the new seed data to the server. The server can generate another candidate synthetic data based on the new seed data. The client apparatus may validate the another candidate synthetic data based on the similarity between the another candidate synthetic data and the original data. This process can be repeated until the number of valid synthetic data reaches n.

If the number of valid synthetic data is n or more (NO in 450), the client apparatus can store the valid synthetic dataset including n pieces of valid synthetic data 470. The client apparatus may transmit the valid synthetic dataset to another device such as a database or server.

Further, a service server or a user terminal may build a certain artificial intelligence model using the valid synthetic dataset 480.

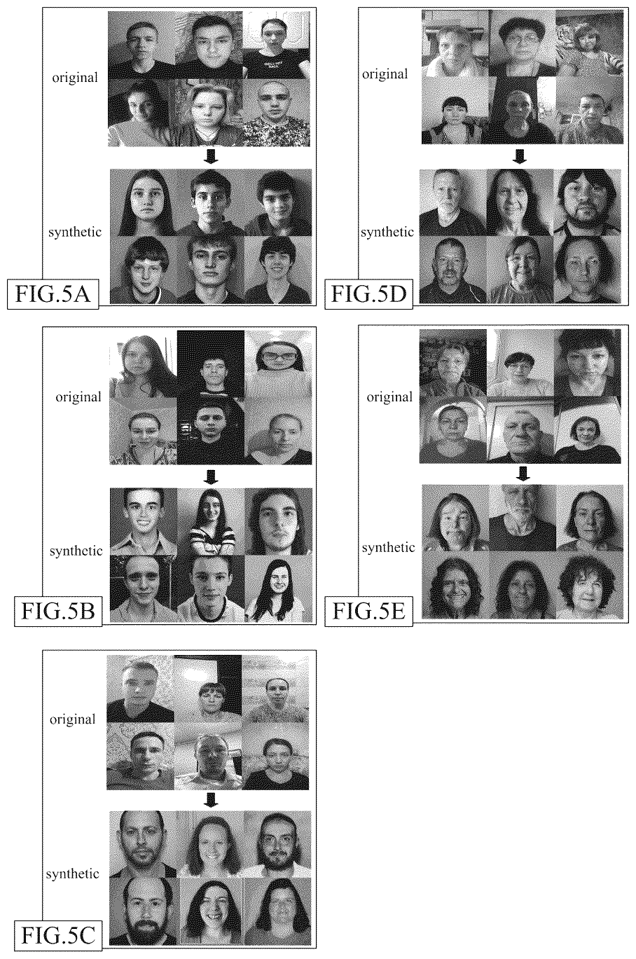

The synthetic data generation technique described in FIG. 2 through FIG. 4 has been validated. The target task for the synthetic data is classification of age in facial images. A generative model is used for the data generation model. A differentially private diffusion probabilistic model is used for the data generation model. The generative model generates synthetic images that preserve significant features for classifying age from the facial images while the personal information that could identify an individual has been obfuscated. In this case, the personal information is visual features in face image. The result of the generative model is described in FIGS. 5A-5E.

FIGS. 5A-5E are an example of generated synthetic data. The arrows in FIGS. 5A-5E indicate the relationship between the synthetic images and their source images (the original images). FIG. 5A shows an example of the original images and the synthetic images for the age group 18-20 years. FIG. 5B shows an example of the original images and the synthetic images for the age group 21-30 years. FIG. 5C shows an example of the original images and the synthetic images for the age group 31-40 years. FIG. 5D shows an example of the original images and the synthetic images for the age group 41-50 years. FIG. 5E shows an example of the original images and the synthetic images for the age group 51-60 years. In FIGS. 5A-5E, the synthetic images are entirely different from the original images. Hence, it is difficult to identify an individual of the original images from the synthetic images. The personal information which can identify an individual in the original images is obfuscated.

Table 1 below shows the results of age group classification using the original images and the synthetic images shown in FIGS. 5A-5E. The classification models have been trained based on the original images and the synthetic images respectively. Table 1 shows the accuracy of the classification models for all age groups. The classification performance using synthetic images is slightly higher than that using the original images. Therefore, the aforementioned synthetic image generation technique is highly applicable for the target task without leaking the personal information.

TABLE 1

| | Original images | Synthetic images |
|---|---|---|
| Accuracy | 50.4 | 55.6 |

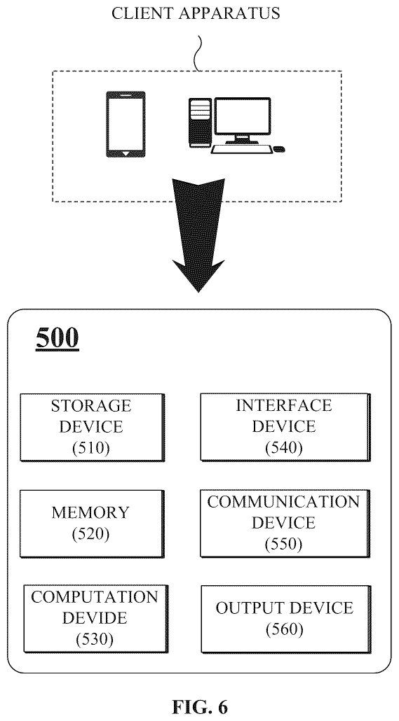

FIG. 6 illustrates an example of a client apparatus 500 for generating synthetic data. The client apparatus 500 shown in FIG. 3 corresponds to the client apparatus 110 shown in FIG. 1. The client apparatus 500 is an apparatus that collects the synthetic dataset based on the original data including the personal information. The client apparatus 500 may be implemented in any of various forms, such as a smart device, a person computer (PC), a wearable device, a IoT device, or a chipset device with embedding software.

The client apparatus 500 may include a storage device 510, a memory 520, a computation device 530, an interface device 540, and a communication device 550. Alternatively, the client apparatus 500 may include a storage device 510, a memory 520, an computation device 530, an interface device 540, a communication device 550, and an output device 560.

The storage device 510 may store the original data. The original data can be any type of data such as images, videos, text, speech, etc. The original data may include the personal information. The personal information may be included in specific visual features, certain regions of an image, specific objects in an image, specific words in text, or features of speech, etc.

The storage device 510 may store seed data which is generated from the original data.

The storage device 510 may store programs or a model for extracting features from the original data and candidate synthetic data.

The storage device 510 may store the candidate synthetic data, a candidate synthetic dataset including multiple candidate synthetic data and a synthetic dataset including multiple synthetic data.

The storage device 510 may store valid synthetic data selected from the candidate synthetic data. The storage device 510 may store a valid synthetic dataset including multiple valid synthetic data.

The storage device 510 may store source code or programs for controlling data preprocessing, feature extraction, similarity calculations between the original data and candidate synthetic data.

The storage device 510 may store source code or programs that control data preprocessing, detection of information of interest, replacement of information of interest, restoration of information of interest, and the like.

The memory 520 may store data generated in the process of generating and collecting synthetic data.

The interface device 540 is a device that receives certain information or data.

The interface device 540 may receive the original data from input devices or external objects.

The interface device 540 may transmit the valid synthetic dataset to an external apparatus.

The interface device 540 may transfer received data from the communication device 550 into the internal components of the client device 500.

The communication device 550 is a device that receives and transmits certain information through a wired or wireless network.

The communication device 550 may receive the original data from external object.

The communication device 550 may receive the candidate synthetic data or the candidate synthetic dataset from a server.

The communication device 550 may transmit the seed data to the server.

The communication device 550 may transmit the valid synthetic data or the valid synthetic dataset to the server or to external objects.

Furthermore, the interface device 540 may include a configuration that transmits information or data received through the communication device 550 to the client apparatus 500.

The computation device 530 may generate seed data. The seed data can be generated using one of various techniques. As mentioned before, the seed data may be generated based on a seed generation model, such as Stable Diffusion, ChatGPT, Llama2, etc.

It is required that the computation device 530 generate the seed data that has a similar distribution of features to that of the original data, while simultaneously the seed data with the personal information in the original data has been removed or obfuscated.

In one embodiment, the seed generation model may have been trained to generate the seed data with a similar distribution of features to the original data, and with the personal information in the original data removed or obfuscated.

In another embodiment, the client apparatus 110 can generate the seed data with prompt engineering with the seed generation model such as LLM. The prompt engineering has been processed to generate the seed data with a similar distribution of features to the original data, and with the personal information in the original data removed or obfuscated.

The computation device 530 may generate multiple candidate seed data (candidate seed dataset). The computation device 530 can select at least one valid seed data from the candidate seed dataset based on the similarity between a candidate seed data and the original data.

The computation device 530 may extract features from the original data. For example, the computation device 530 may extract features from the original data using an encoder.

The computation device 530 may extract features from the candidate synthetic data. For example, the computation device 530 may extract features from the candidate synthetic data using an encoder.

The computation device 530 may calculate the similarity between the original data and candidate synthetic data. The computation device 530 may compare the features of the original data and that of the candidate synthetic data to calculate their similarity. The similarity can be measured based on the distribution difference or distance between the features of the original data and that of the candidate synthetic data. The similarity score can be calculated based on the feature differences or the distance. The similarity score may have a higher value as the similarity increases.

The computation device 530 may select the valid synthetic data based on similarity to the original data. For example, the computation device 530 may select candidate synthetic data whose the similarity score is higher a certain threshold as the valid synthetic data.

The computation device 530 may evaluate the similarity of each synthetic data in the candidate synthetic data set, and select at least one valid synthetic data. The computation device 530 may select the valid synthetic dataset including multiple valid synthetic data.

The communication device 550 may transmit the valid synthetic data or the valid synthetic dataset as input data to the server.

The computation device 530 may select valid synthetic data from the candidate synthetic dataset as new seed data. In this case, the communication device 550 may transmit the new seed data as input data to the server for generate another candidate synthetic data. Further, the communication device 550 may receive the another candidate synthetic data from the server. And, the computation device 530 may validate the another candidate synthetic data based on the similarity score.

When a certain number of valid synthetic data are selected, the computation device can control to store the entire valid synthetic dataset in the storage device (510.

The computation device 530 may be a device, such as a processor (CPU, GPU, etc.), an application processor (AP), an arithmetic device or a chip embedded with a program that processes data and processes a certain operation.

The output device 560 may output an interface screen the synthetic data generation process, the original data, the candidate synthetic data, and the valid synthetic data.

When implemented in software, a computer-readable storage medium for storing one or more programs (software modules) may be provided. One or more programs stored in a computer-readable storage medium are configured for execution by one or more processors in an electronic device. The one or more programs include instructions that cause the electronic device to perform the methods according to the embodiments described in the specification.

The non-transitory computer readable medium refers to a medium that stores data semi-permanently (e.g., the storage device 510) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

In one or more aspects of the present disclosure, a method is provided for generating synthetic data without leaking personal information. The method may be carried out by a hardware apparatus (e.g., 110, 120 or 500). In one or more examples, the hardware apparatus is an electronic hardware apparatus. In one or more examples, the hardware apparatus may include the seed generation model, the data generation model.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method of generating synthetic data, the method comprising:
receiving, by a client apparatus, original data including personal information;
acquiring, by the client apparatus, seed data based on the original data;
transmitting, by the client apparatus, the seed data to a server;
receiving, by the client apparatus, first candidate synthetic data which is generated based on the seed data from the server;
validating, by the client apparatus, the first candidate synthetic data based on a similarity between the first candidate synthetic data and the original data; and
storing, by the client apparatus, the first candidate synthetic data as a member of synthetic dataset if the first candidate synthetic data is valid synthetic data based on the validation result,
wherein the seed data includes information which the personal information is removed or obfuscated.

2. The method of claim 1, wherein acquiring the seed data include:
inputting the original data or prompts extracted from the original data into a deep learning model; and acquiring the seed data from output of the deep learning model.

3. The method of claim 1, wherein acquiring the seed data include:
receiving, by the client apparatus, a public dataset;
extracting, by the client apparatus, features of each data from the public dataset;
extracting, by the client apparatus, features of the original data
selecting, by the client apparatus, the seed data from the public dataset based on a similarity between a feature distribution of the original data and a feature distribution of the each data in the public dataset.

4. The method of claim 1, further comprising:
transmitting, by the client apparatus, the first candidate synthetic data as new seed data to the server;
receiving, by the client apparatus, second candidate synthetic data which is generated based on the new seed data from the server;
validating, by the client apparatus, the second candidate synthetic data based on a similarity between the second candidate synthetic data and the original data;
selecting, by the client apparatus, the second candidate synthetic data as valid synthetic data if the similarity is higher above a threshold; and
storing, by the client apparatus, the synthetic dataset including the first candidate synthetic data and the second candidate synthetic data.

5. The method of claim 1, wherein the first candidate synthetic data is generated using at least one of a sample-based variation model, a demonstration-based variation model and a deep learning model.

6. The method of claim 1, wherein validating the first candidate synthetic data include:
extracting, by the client apparatus, features of the first candidate synthetic data;
extracting, by the client apparatus, features of the original data;
selecting, by the client apparatus, the first candidate synthetic data as the valid synthetic data, if the a similarity between a feature distribution of the original data and a feature distribution first candidate synthetic data is above a threshold.

7. A client apparatus for collecting synthetic data, the client apparatus comprising:
an interface device configured to receive original data including personal information;
a communication device configured to receive first candidate synthetic data which is generated based on seed data from the server;
a computation device configured to validate the first candidate synthetic data based on a similarity between the first candidate synthetic data and the original data, and determine the first candidate synthetic data as valid synthetic data if the similarity is higher above a threshold; and
a storage device configured to store the first candidate synthetic data as a member of candidate synthetic dataset if the first candidate synthetic data is valid synthetic data based on the validation result,
wherein the seed data is generated from the original data, and the seed data includes information which the personal information is removed or obfuscated.

8. The client apparatus of claim 7, wherein the computation device configured to input the original data or prompts extracted from the original data into a deep learning model for generating the seed data.

9. The client apparatus of claim 7, wherein the computation device configured to select the seed data from a public dataset based on a similarity between a feature distribution of the original data and a feature distribution of the each data in the public dataset.

10. The client apparatus of claim 7,
wherein the communication device configure to transmit he first candidate synthetic data as new seed data to the server, and receive second candidate synthetic data which is generated based on the new seed data from the server,
wherein the computation device configured to validate the second candidate synthetic data based on a similarity between the second candidate synthetic data and the original data, and determine the second candidate synthetic data as valid synthetic data if the similarity is higher above a threshold, and
wherein the storage device configured to store the synthetic dataset including the first candidate synthetic data and the second candidate synthetic data.

11. The client apparatus of claim 7, wherein the first candidate synthetic data is generated using at least one of a sample-based variation model, a demonstration-based variation model and a deep learning model.

12. The client apparatus of claim 7, wherein the computation device configured to extract features of the first candidate synthetic data, extract features of the original data, and select the first candidate synthetic data as the valid synthetic data, if the a similarity between a feature distribution of the original data and a feature distribution first candidate synthetic data is above a threshold.

13. A system for generating synthetic data, the system comprising:
a client apparatus configured to
acquire seed data from original data including personal information,
transmit the seed data to a server,
receive first candidate synthetic data from the server,
validate first candidate synthetic data based on a similarity between the first candidate synthetic data and the original data, and determine the first candidate synthetic data as valid synthetic data if the similarity is higher above a threshold, and
store the first candidate synthetic data as a member of synthetic dataset, and
the sever configured to generate the first candidate synthetic data from the seed data using at least one of a sample-based variation model, a demonstration-based variation model and a deep learning model.

14. The system of claim 13, wherein the client apparatus configured to input the original data or prompts extracted from the original data into a deep learning model for generating the seed data.

15. The system of claim 13, wherein the client apparatus configured to select the seed data from a public dataset based on a similarity between a feature distribution of the original data and a feature distribution of the each data in the public dataset.

16. The system of claim 13,
wherein the client apparatus further configured to
transmit he first candidate synthetic data as new seed data to the server,
receive second candidate synthetic data which is generated based on the new seed data from the server,
validate the second candidate synthetic data based on a similarity between the second candidate synthetic data and the original data,
determine the second candidate synthetic data as valid synthetic data if the similarity is higher above a threshold, and
store the synthetic dataset including the first candidate synthetic data and the second candidate synthetic data.
